(19) United States
(12) Patent Application Publication
(10) Pub. No.: US 2021/0387438 A1
(43) Pub. Date: Dec. 16, 2021

(54) Bamboo Unit

(71) Applicant: BORNEMANN UND WACHNER GBR, Hattingen (DE)

(72) Inventor: Joachim Wachner, Hattingen (DE)

(21) Appl. No.: 17/288,275

(22) PCT Filed: Oct. 29, 2019
(86) PCT No.: PCT/EP2019/079548

§ 371 Date: Apr. 23, 2021

(30) Foreign Application Priority Data
Oct. 29, 2018 (DE) 10 2018 126 956.0

(51) Int. Cl. B32B 3/14; B27J 1/00; B32B 9/02; B32B 9/06; B32B 9/04

(52) U.S. Cl. CPC B32B 3/14; B27J 1/003; B32B 9/02; B32B 9/06; B32B 9/042; B32B 2250/03; B32B 2607/02; B32B 2307/102; B32B 2307/304; B32B 2419/04; B32B 2479/00; B32B 2553/00; B32B 2250/40

(57) ABSTRACT

The invention relates to a bamboo unit (1) comprising at least one bamboo element (2), wherein the bamboo element (2) can be produced from several bamboo parts (3), wherein the bamboo parts (3) can be arranged next to each other in at least one plane, and wherein the individual bamboo parts (3) are connected to each other in a force- and/or form-locking manner.

The present invention relates to a bamboo unit according to the present patent claim 1 as well as a bamboo assembly according to the present patent claim 6, a method for producing a bamboo unit according to the present patent claim 7 as well as the application of a bamboo unit according to the present patent claim 10.

Bamboo units as well as methods for the production of bamboo units are known and are often used for packaging, cladding or in furniture construction. For this purpose, a bamboo is processed in such a way that panels can be formed from it. Bamboo units are known from DE 30 35 323 A1 and EP 0 864 020 B1, which comprise bamboo parts arranged in layers. The disadvantage of known bamboo units is that the different bamboo parts are often connected to each other in a complicated way. For this purpose, the existing silicone skin of the bamboo culms is usually removed at great expense and processed further to form square or rectangular bamboo lamellae, in particular to simplify a material-locking connection (such as by gluing).

It is therefore an object of the present invention to at least partially overcome the foregoing disadvantages. In particular, it is an object of the present invention to form a bamboo unit which can be produced in a CO₂ and/or environmentally friendly manner and at low cost, while at the same time being particularly hard-wearing.

Further features and details of the invention are apparent from the dependent claims, the description and the figures. Features and details which have been described in connection with the unit according to the invention naturally also apply in connection with the assembly according to the invention, the method according to the invention and the application according to the invention, and vice versa in each case, so that reference is or can always be made mutually with regard to the disclosure of the individual aspects of the invention.

According to the invention, the object is solved by a bamboo unit which comprises at least one bamboo element. Bamboo elements can be preferably produced from several bamboo parts, which can be arranged next to each other in at least one plane. The individual bamboo parts are preferably connected to each other in a force- and/or form-locking manner. A bamboo unit thereby consists of at least one bamboo element which is composed of a plurality of bamboo parts. The bamboo parts are preferably arranged parallel to each other in a plane next to each other and thus form the bamboo element. The individual bamboo parts may be connected to each other in a force-locking manner. In connections in a force-locking manner, a force is exerted on the adjacent surfaces to be connected. In this case, this force is so great that the various bamboo parts are prevented from shifting relative to each other. Alternatively or additionally, the individual bamboo parts can be connected to each other in a form-locking manner. Connections in a form-locking manner are formed by interlocking at least two bamboo parts. Furthermore, a form-locking connection can also be produced by connecting means.

Advantageously, the present case does not require a material-locking connection in which two parts to be connected are held together by atomic or molecular forces, such as in particular by gluing, welding and/or soldering. The raw material bamboo is a sweet grass and comprises hollow or fully marrow formed culms. The culms are surrounded (from the outside or externally) by a silicone skin which protects the bamboo from external influences and damage. In the case of a force- and/or form-locking connection, the silicone skin can advantageously remain on the bamboo parts during further processing. As a result, the waste produced can be significantly reduced and the stability of the bamboo parts and thus of the entire bamboo unit can be significantly increased. Furthermore, the silicone skin comprises a natural protective layer that protects against environmental influences, such as moisture in particular. The fact that the silicone skin remains on the bamboo parts also advantageously saves time during the production of the bamboo elements, in that it does not have to be additionally removed from the culms or from the bamboo parts before processing. In total, this makes the bamboo unit more cost-effective.

Within the scope of the invention, it is also conceivable that the individual bamboo parts can be arranged at least partially parallel or uni-directionally to each other. The connection of the bamboo parts to each other can advantageously be carried out without adhesives. By arranging the individual bamboo parts parallel or uni-directionally to each other in a plane, a layered structure is formed which comprises a uniform structure. A uni-directional arrangement is advantageously constructed in such a way that the bamboo parts are always aligned in the same direction. The bamboo parts comprise a slight curvature due to the natural round shape of the bamboo. In the arrangement of the bamboo parts relative to each other, the convex side of one bamboo part is advantageously arranged against a concave side of another bamboo part. Thus, it is feasible that the bamboo parts contact each other at least partially. This means that the formation of cavities in the bamboo element can be avoided to the greatest possible extent. This type of layered structure allows uniform bamboo elements to be produced from the bamboo parts, which are thus easier to handle and further process in further use. This also makes it easier to assemble the bamboo elements into bamboo units or bamboo assemblies. It is also possible to use cover layers when assembling bamboo units, which can be applied to the bamboo units. A simplified application can be realized by a uniform design of the bamboo parts forming a layer structure.

It is also possible for the bamboo parts to form an inherently flat upper side and/or lower side of the bamboo element. The formation of a flat upper or lower side can be simplified in particular by removing or adjusting the protruding outer edges of the bamboo parts. Preferably, the cutting edges of the bamboo are straightened so that the flat upper and/or lower side can be formed. This makes it possible to realize a layer structure with a uniform structure, which advantageously can be installed more easily. Particularly advantageously, a cover layer can be applied in a simplified manner to a flat upper or lower side.

It can also be advantageous if the bamboo parts are connected to each other by means of connecting means in a force- and/or form-locking manner. Alternatively or additionally, it is conceivable that the connecting means are connected to the bamboo parts in particular via an adhesive. Furthermore, it is particularly possible that the connecting means are dowels. In this way, the bamboo parts can be securely connected to each other. Likewise, even when connecting means are used, the silicone skin can remain on the bamboo parts. Furthermore, it is advantageous if only the connecting means are connected to the bamboo parts in a material-locking manner, but the bamboo parts are connected to each other in a form- and/or force-locking manner. Due to the material-locking arrangement of the connecting means, better stability can be achieved, since the connecting means remain reliably on the bamboo parts.

The connecting means can advantageously be formed from bamboo and/or wood and/or plastic and/or metal. The length of the connecting means depends on the material. Dowels made of bamboo have the advantage that they can be produced in a particularly environmentally friendly and cost-effective manner and also consist of the same material as the bamboo unit. Dowels made of wood have the advantage that they can be produced in a particularly environmentally friendly and cost-effective manner and also consist of a similar material to the bamboo unit. Plastic dowels, on the other hand, are advantageously particularly light and hard-wearing. Metal dowels are designed to be particularly stable. The length of the dowels corresponds at least to the width of two bamboo parts that are connected to each other and at most to the length of an entire bamboo element.

Advantageously, the connecting means are connected to the bamboo parts by a material-locking connection. Preferably, they are glued to the bamboo parts. Resins are particularly suitable as adhesives. Preferably, at least one of the following adhesives is used: epoxy resin, polyester resin, in particular unsaturated polyester resin, polyurethane glue, dispersion glue, in particular formaldehyde-free dispersion glue, resorcinol-formaldehyde resin glue, phenol-formaldehyde resin glue. Epoxy resins have good mechanical properties and good temperature and chemical resistance, and are also environmentally friendly. Polyester resins can exhibit great hardness and can also be used in an environmentally friendly manner. Polyurethane glue as well as dispersion glue are wood glues and can be made from natural raw materials in particular. Polyurethane glue and dispersion glue can also be used in an environmentally friendly manner. Formaldehyde resin glues are also particularly resistant to weathering and heat.

Likewise, it is conceivable within the scope of the invention that a width of the bamboo elements is formed by a height dimension (or length dimension) of the bamboo parts. The bamboo parts are made from the raw material bamboo. Thereby, the bamboo parts can be cut out of the bamboo in different sizes. The size of the bamboo parts can thereby determine the height dimension, which the bamboo element comprises. These thus advantageously form the width of the bamboo elements. The bamboo elements can preferably have a width of 10 to 1,000 mm, in particular preferably of 50 to 500 mm, especially preferably of 100 to 150 mm. Approximately 10 bamboo elements thereby form a bamboo unit, wherein the bamboo unit can in particular have a size of 500×5,000 mm, preferably of 1,000×2,000 mm, particularly preferably of 1,220×2,440 mm. The size of the bamboo parts may preferably be 0.1 to 10 cm, more preferably 0.5 to 5 cm, particularly preferably 1 to 3 cm, and a width of 0.1 to 10 cm, more preferably 0.5 to 5 cm, particularly preferably 1 to 2 cm.

According to a further aspect of the invention, an assembly is comprised comprising at least two bamboo elements. The bamboo elements thereby comprise at least two bamboo parts each. Further, the bamboo parts are arranged next to each other in a plane and are thereby connected to each other in a force- and/or form-locking manner. Furthermore, the bamboo elements can be arranged vertically above each other or horizontally next to each other. The bamboo elements can thereby be connected to each other by a cover layer. The cover layer is arranged on at least one bamboo element. Advantageously, it is conceivable that the cover layer consists at least partially of cardboard, paper, bamboo, wood and/or plastic. Cardboard has the advantage of being particularly environmentally friendly and yet stable. Paper can also be produced and degraded in an environmentally friendly manner. In the case of a bamboo cover layer, it is advantageous that this is made of the same material as the bamboo elements. They can also be produced and degraded in an environmentally friendly manner. In addition, bamboo is very stable. Wood is also a renewable raw material, which also comprises a high stability. A plastic cover layer is particularly stable and resistant to external environmental influences. A cover layer can be placed on the bamboo elements and, in particular, be connected to the bamboo elements, whether in a force-locking, form-locking or material-locking manner. Likewise, a cover layer can also remain sprayed on as a liquid material. Advantageously, spraying produces a uniform application to the bamboo element. A cover layer has the advantage that it can stabilize the assembly. It is also conceivable for a cover layer to consist of a honeycomb structure, so that this forms a further increased stability. The cover layer can also be glued on. In addition to stability, the cover layer also serves to protect the bamboo assembly so that it is more resistant to environmental influences, such as moisture in particular. In addition, a cover layer can also serve for sound insulation or also create a visually pleasing impression. Furthermore, it is conceivable that the top layer consists of bamboo elements to give a particularly natural visual impression. The ratio of adhesive to bamboo can be as low as 0.1 to 10%, preferably 0.5 to 5%, particularly preferably 1 to 2%. This makes the bamboo assembly more stable and easier to recycle.

It is also possible to insert an intermediate layer next to the cover layer, which is arranged in particular between two bamboo elements. The intermediate layer also serves to provide stability and can be designed, for example, as a honeycomb structure. Such an intermediate layer can further consist of reinforcing material, which contributes to an increased stability of the bamboo element. It is also conceivable that a reinforcing element is introduced into the bamboo element. The reinforcing element can preferably be distributed over the entire surface of the bamboo element or only over part of the surface. Advantageously, a recess is formed in the end faces of the bamboo element by milling. A reinforcing element can be introduced into these recesses. Preferably, the reinforcing element can be introduced into the recess in a material-locking manner, in particular by an adhesive. Preferably, the reinforcing element can be incorporated at right angles to the course of the fibers of the bamboo in the end or head wood of the bamboo element. Advantageously, this can prevent an end offset or a risk of splitting or weakening in the pressure region. In particular, the reinforcing element can thus prevent stresses in the face wood, swell pressure and transverse forces, in particular when connecting means are inserted.

Also essential to the invention is a method for producing a bamboo unit, the method advantageously comprising the following steps: dividing the bamboo into individual bamboo parts, adapting the inner radius to the outer radius of the bamboo parts, and producing bamboo elements from a plurality of bamboo parts by arranging at least two bamboo parts next to each other in a plane. In this method, the individual bamboo parts are connected to each other in a form- and/or force-locking manner. During the dividing, it is advantageous if the bamboo parts are uniform. The bamboo parts are divided in particular by cutting, advantageously by splicing. By splicing, a particularly large amount of bamboo can advantageously be cut into bamboo parts in a particularly short time. Dividing is particularly time-saving and also cost-effective. In addition, the resulting waste of the bamboo can be reduced. Furthermore, it is particularly intended to adapt the inner radius to the outer radius of the bamboo parts. Advantageously, twisted growth or knots as well as capillary walls are also removed by splicing, planing or sawing. For planing, planing knives can advantageously be used whose cutting edge comprises a radius with a size of R40 to R75 (i.e. radius of 40 mm to 75 mm) in order to produce radii that are very similar in size to the natural growth of the bamboo. This means that the cut bamboo parts can also have a radius of 40 mm to 75 mm. Thus, a uniform material thickness can be achieved so that the concave and convex sides of the bamboo parts can be connected flush with each other without creating cavities. For this purpose, the bamboo parts can advantageously be pressed. By such a pressing process, both the convex outer radius and the concave inner radius of the bamboo parts can be straightened. Of course, it is possible to carry out at least one method step in a different order.

It is also conceivable that in a further step of the method the bamboo parts are treated with a (cleaning and/or preservation) solution. Preferably, this is a borax granulate solution. Advantageously, the bamboo parts are thereby protected against insects and an infestation of mold. Decay of the bamboo elements is thus prevented. Alternatively or additionally, the bamboo parts can be thermally treated in a further step. Advantageously, the residual moisture can thus be removed from the bamboo. In particular, the residual moisture can thereby be reduced to <20%, especially preferably to <8%, whereby mold formation can also be prevented. Furthermore, low residual moisture makes the bamboo parts more dimensionally stable against warping, twisting and splitting. In addition, the degree of hardness of the bamboo parts can be increased by thermal treatment.

It is also conceivable that the cutting edges of the bamboo parts formed during dividing are straightened to form a flat top or lower side of the bamboo elements. This makes it possible to realize an evenly built layer structure, which is advantageously easier to install. When arranging the bamboo parts relative to each other, the convex side of one bamboo part is advantageously arranged against a concave side of another bamboo part. Thus, it is feasible that the bamboo parts contact each other at least partially. Straightening is carried out in particular by planing. This type of layer structure enables uniform bamboo elements to be produced from the bamboo parts, making them easier to handle and further process. It is also easier to assemble the bamboo elements into bamboo units or bamboo assemblies.

By the method according to the invention, in particular a bamboo unit according to the invention can be produced. Alternatively or additionally, a bamboo assembly can also be produced by the method according to the invention.

Furthermore, it is provided within the scope of the invention to use the bamboo unit and/or the bamboo assembly for packaging, furniture, worktops, fillings, rear walls and/or wall and ceiling cladding in the interior finishing of containers, in particular shipping containers or buildings, in particular for insulation, sound insulation or heat insulation in the interior finishing of containers and/or buildings. Other possible uses include flooring, in particular as laying boards or decking boards or roof battens for roof extensions.

The assembly or unit according to the invention can, of course, be produced using the method according to the invention. The bamboo assemblies or bamboo elements thus produced can of course be applied according to the invention.

Further measures improving the invention will be apparent from the following description of some examples of embodiments of the invention, which are shown schematically in the figures. All features and/or advantages arising from the claims and the description or the figures, including constructional details, spatial arrangements and method steps, may be essential to the invention both individually and in a wide variety of combinations. It should be noted that the figures are descriptive only and are not intended to limit the invention in any way.

The figures show:

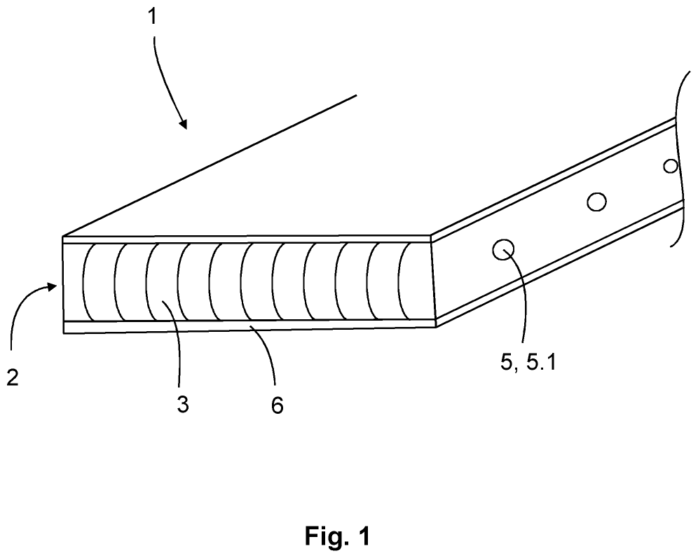

FIG. 1 a top view of a bamboo unit according to the invention,

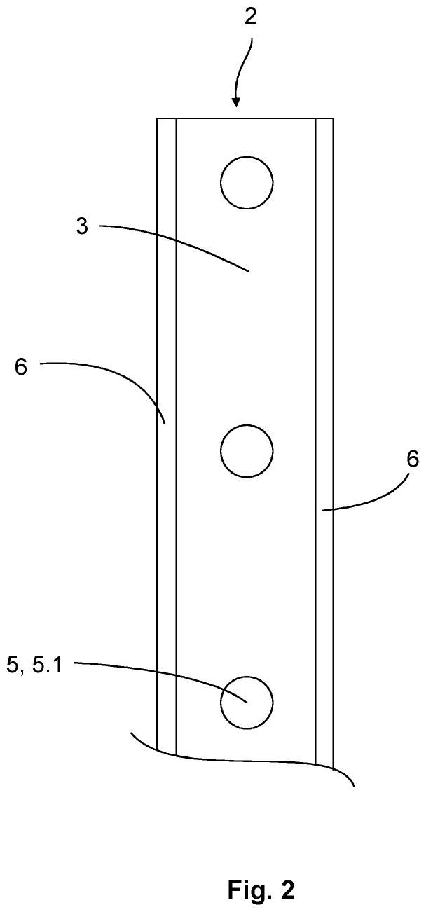

FIG. 2 a side view of a bamboo unit according to the invention,

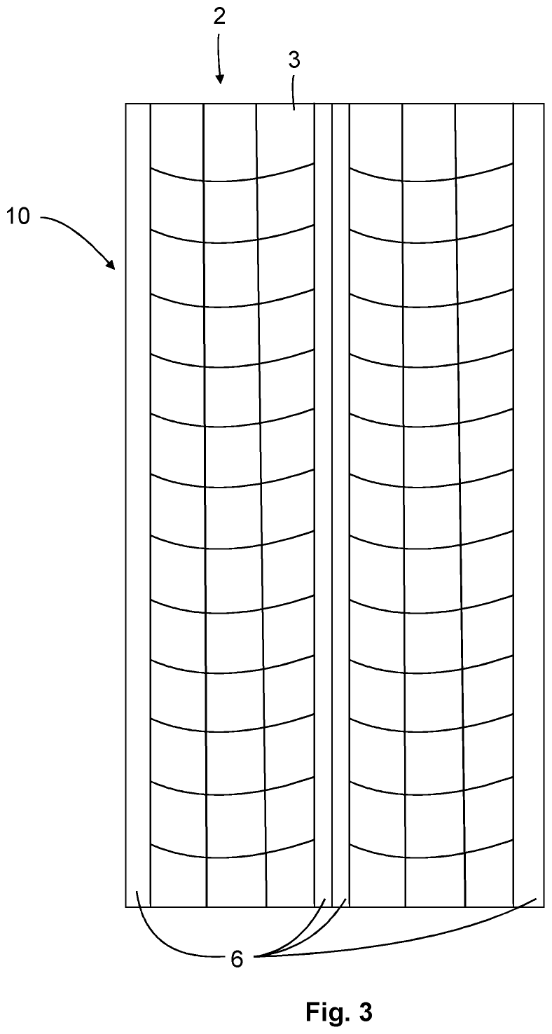

FIG. 3 a side view of a bamboo assembly according to the invention,

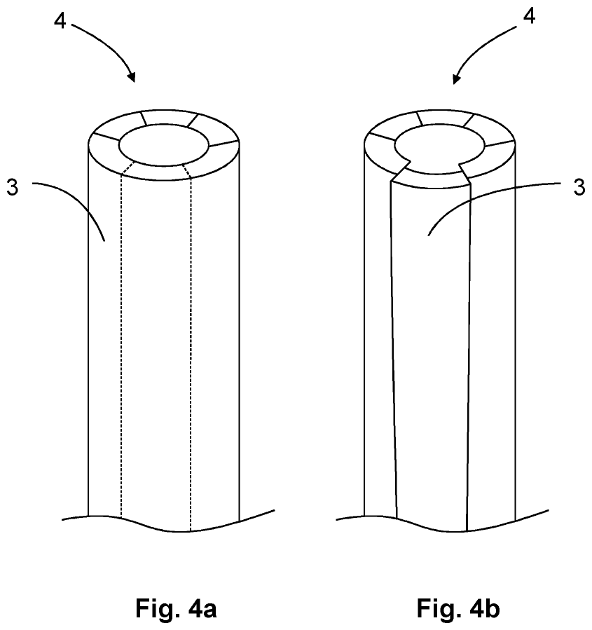

FIG. 4a a bamboo to be divided as raw material,

FIG. 4b a divided bamboo as raw material,

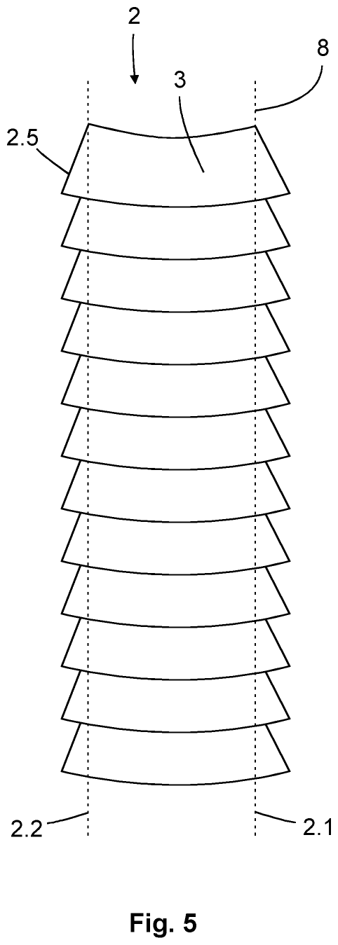

FIG. 5 a bamboo element in side view,

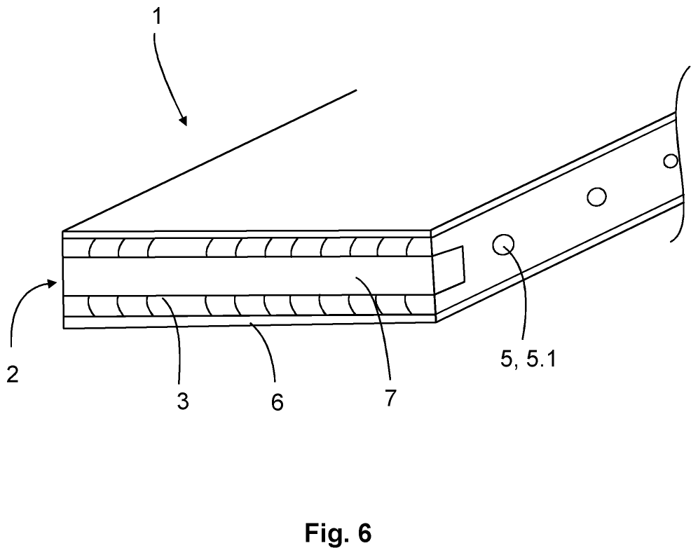

FIG. 6 a top view of a bamboo unit.

In the following figures, the identical reference signs are used for the same technical features, even of different embodiments.

FIG. 1 shows a top view of a bamboo unit 1, which consists of a bamboo element 2. The bamboo element 2 consists of several bamboo parts 3. A bamboo unit 1 consists of at least one bamboo element 2, which is composed of several bamboo parts 3. The bamboo parts 3 are preferably arranged parallel to each other in a plane next to each other and thus form the bamboo element 2. The individual bamboo parts 3 are thereby connected to each other in a force- and/or form-locking manner. The bamboo parts 3 are connected to each other by connecting means 5, in particular dowels 5.1. The dowels are thereby arranged in the longitudinal side of the bamboo part. The bamboo unit is also covered above and below with a cover layer 6.

FIG. 2 shows a side view of a bamboo element 2, wherein a bamboo part 3 can be seen in the side view, which comprises recesses for connecting means 5, in particular dowels 5.1. In this case, the dowels are inserted into the bamboo parts 3 and are connected to the recesses in a material-locking manner. Preferably, they are glued to the bamboo parts 3. This allows the bamboo parts 3 to be securely connected to each other. The connecting means 5 thus remain reliably in the bamboo element 2. Likewise, the silicone skin can also remain on the bamboo parts 3 when connecting means are used. Advantageously, the connecting means 5 are made of bamboo and/or wood. Cover layers 6 are attached to both sides of the bamboo unit 1 or the bamboo part 3, in particular for further reinforcement or protection.

FIG. 3 shows a bamboo assembly 10, which comprises two bamboo elements 2 lying next to each other, which are formed from a plurality of bamboo parts 3. The bamboo elements 2 comprise in each case at least two bamboo parts 3. The bamboo parts 3 are furthermore arranged next to each other in a plane and are thereby connected to each other in a force- and/or form-locking manner. Cover layers 6 are arranged between the bamboo elements 2. The cover layer 6 is thereby arranged on at least one bamboo element 2. Advantageously, it is conceivable that the cover layer 6 consists at least partially of cardboard, paper, bamboo, wood and/or plastic. Furthermore, it is possible that an intermediate layer is inserted next to the cover layer, which is arranged in particular between two bamboo elements. Furthermore, the intermediate layer also serves to provide stability. The cover layers 6 can be applied to the bamboo elements 2, in particular by spraying them on or gluing them to the bamboo elements 2. In addition, a cover layer 6 can likewise serve for sound insulation or also create a visually pleasing impression. Furthermore, it is conceivable that the top layer consists of bamboo elements 2 in order to convey a particularly natural visual impression.

FIG. 4a shows the bamboo 4 or the bamboo culm 4, which belongs to the sweet grasses, as a raw material. The bamboo culms 4 are largely hollow. In FIG. 4a, a bamboo culm 4 is shown which already comprises cutting edges 2.5 at which the bamboo culm 4 is divided into bamboo parts 3 (with the aid of a cutting knife). This dividing is advantageously carried out as cutting or splicing. FIG. 4b shows a bamboo part 3 which has already been cut out of the bamboo culm 4. The outer surface of the bamboo culm 4 is provided with a natural silicone skin, which is preferably retained during the production of the bamboo parts 3 and is therefore not removed at great expense.

FIG. 5 shows the arrangement of several bamboo parts 3 next to each other, which are arranged to form a bamboo element 2. The cutting edges 2.5 shown in FIGS. 4a and 4b are straightened to form a straightening edge 8. Straightening is advantageously performed by planing. As a result, the straightening edges 8 comprise a flat upper and lower side 2.1, 2.2, so that they can be installed more easily and the cover layer 6 can also be applied more easily to the bamboo elements.

FIG. 6 shows a bamboo unit 1, with a bamboo element 2 formed from several bamboo parts 3, wherein a reinforcing element 7 is inserted into the bamboo parts. The reinforcing element 7 may be distributed over the entire surface of the bamboo unit 2 or only over part of the surface. Preferably, the reinforcing element 7 is arranged only in the end region of the bamboo element 2. Advantageously, a recess is formed in the end faces of the bamboo element 2 by milling. A reinforcing element 7 can then be inserted into these recesses. Preferably, the reinforcing element 7 can be introduced into the recess of the bamboo element 2 in a material-locking manner, in particular by an adhesive. Preferably, the reinforcing element 7 can be incorporated at right angles to the fiber in the end or head wood of the bamboo element 2.

The foregoing explanations of the embodiments describe the present invention exclusively in the context of examples. Of course, individual features of the embodiments can be freely combined with each other, provided that this is technically reasonable, without leaving the scope of the present invention.

### LIST OF REFERENCE SIGNS

1 bamboo unit

2 bamboo element

2.1 upper side of the bamboo element 2

2.2 lower side of the bamboo element 2

2.3 inner radius

2.4 outer radius

2.5 cutting edges

3 bamboo part

4 bamboo/bamboo culm

5 connecting means

5.1 dowel

6 cover layer

7 reinforcing element

8 straightening edge

10 bamboo assembly

100 method

101 dividing

102 adapting

103 producing

1-11. (canceled)

12. A bamboo unit comprising at least one bamboo element, wherein the bamboo element can be produced from several bamboo parts, wherein the bamboo parts can be arranged next to each other in at least one plane, and
wherein the individual bamboo parts are connected to each other in at least a force- or form-locking manner.

13. The bamboo unit according to claim 12,
wherein
at least the individual bamboo parts are arranged at least parallel or uni-directionally to each other and are connected to each other or
a bamboo part is formed of exactly one bamboo.

14. The bamboo unit according to claim 12,
wherein
at least the individual bamboo parts are arranged at least parallel or uni-directionally to each other and are connected to each other without adhesives or a bamboo part is formed of exactly one bamboo and comprises its silicone skin.

15. The bamboo unit according to claim 12,
wherein
the bamboo parts form at least an inherently flat upper or lower side of the bamboo element.

16. The bamboo unit according to claim 12,
wherein
the bamboo parts are connected to each other by means of connecting means in at least a force- or form-locking manner.

17. The bamboo unit according to claim 16,
wherein
the connecting means are connected to the bamboo parts via an adhesive.

18. The bamboo unit according to claim 16,
wherein
the connecting means are dowels.

19. The bamboo unit according to claim 12,
wherein
a width of the bamboo elements is formed by a height dimension of the bamboo parts.

20. A bamboo assembly comprising at least two bamboo elements, each comprising at least two bamboo parts,
wherein the bamboo parts are arranged next to each other in a plane and are connected to each other in at least a force- or form-locking manner, and
wherein at least two bamboo elements are arranged one above the other, which can be connected to each other by at least one intermediate layer, wherein the intermediate layer is arranged on at least one bamboo element.

21. The bamboo assembly according to claim 20,
wherein
the intermediate layer comprises at least partially cardboard, paper, bamboo or wood.

22. A method for producing a bamboo unit comprising the following steps:
dividing the bamboo into individual bamboo parts,
adapting the inner radius to the outer radius of the bamboo parts,
producing bamboo elements from a plurality of bamboo parts by arranging at least two bamboo parts next to each other in a plane,
wherein
the individual bamboo parts are connected to each other in at least a force- or form-locking manner.

23. The method according to claim 22,
wherein
at least the bamboo parts are treated with a solution in a further step or the bamboo parts are thermally treated in a further step.

24. The method according to claim 22,
wherein
the cutting edges of the bamboo parts formed during dividing are straightened to form a flat top or lower side of the bamboo elements.

25. The method according to claim 22, for producing at least a bamboo unit comprising at least one bamboo element, wherein the bamboo element can be produced from several bamboo parts, wherein the bamboo parts can be arranged next to each other in at least one plane, and wherein the individual bamboo parts are connected to each other in at least a force- or form-locking manner or a bamboo assembly comprising at least two bamboo elements, each comprising at least two bamboo parts, wherein the bamboo parts are arranged next to each other in a plane and are connected to each other in at least a force- or form-locking manner, and wherein at least two bamboo elements are arranged one above the other, which can be connected to each other by at least one intermediate layer, wherein the intermediate layer is arranged on at least one bamboo element.

26. Application of at least a bamboo unit comprising at least one bamboo element, wherein the bamboo element can be produced from several bamboo parts, wherein the bamboo parts can be arranged next to each other in at least one plane, and wherein the individual bamboo parts are connected to each other in at least a force- or form-locking manner or a bamboo assembly comprising at least two bamboo elements, each comprising at least two bamboo parts, wherein the bamboo parts are arranged next to each other in a plane and are connected to each other in at least a force- or form-locking manner, and wherein at least two bamboo elements are arranged one above the other, which can be connected to each other by at least one intermediate layer, wherein the intermediate layer is arranged on at least one bamboo element at least for packaging, furniture, worktops, fillings, floors, rear walls or wall and ceiling cladding in the interior finishing of containers.
